(19) United States
(12) Patent Application Publication
(10) Pub. No.: US 2024/0053069 A1
(43) Pub. Date: Feb. 15, 2024

(54) ACCUMULATOR FOR COMPRESSOR

(71) Applicant: Samsung Electronics Co., Ltd., Suwon-si (KR)

(72) Inventors: Soodol PARK, Suwon-si (KR); Munseong KWON, Suwon-si (KR); Joonhyung KIM, Suwon-si (KR); Jaewoo PARK, Suwon-si (KR); Hyolim HEO, Suwon-si (KR)

(21) Appl. No.: 18/496,235

(22) Filed: Oct. 27, 2023

Related U.S. Application Data
(63) Continuation of application No. PCT/KR2022/005990, filed on Apr. 27, 2022.

(30) Foreign Application Priority Data
Jun. 8, 2021 (KR) 10-2021-0074153

(51) Int. Cl. F25B 43/00; B01D 46/00; F15B 1/04

(52) U.S. Cl. CPC F25B 43/006; B01D 46/0031; F15B 1/04

(57) ABSTRACT

An accumulator for a compressor on a horizontal-type compressor is provided. The accumulator includes a body provided on one side of a horizontal-type compressor so as to be perpendicular to a center line of the horizontal-type compressor, a stand pipe protruding into the body from a lower surface of the body, a suction opening provided on a side surface of the body, a baffle which is provided above the stand pipe inside the body and includes a plurality of baffle holes, and a screen provided above the baffle.

### CROSS-REFERENCE TO RELATED APPLICATION(S)

This application is a continuation application, claiming priority under § 365(c), of an International application No. PCT/KR2022/005990, filed on Apr. 27, 2022, which is based on and claims the benefit of a Korean patent application number 10-2021-0074153, filed on Jun. 8, 2021, in the Korean Intellectual Property Office, the disclosure of which is incorporated by reference herein in its entirety.

### BACKGROUND

### 1. Field

The disclosure relates to an accumulator for a compressor. More particularly, the disclosure relates to an accumulator for a horizontal compressor.

### 2. Description of the Related Art

Generally, an accumulator, which is a gas-liquid separator, is disposed in a compressor used in a refrigerating apparatus to prevent instantaneous excessive intake of liquid refrigerant and oil.

Recently, horizontal compressors have been used to increase case capacity of commercial refrigerators such as showcases. In particular, because the amount of liquid refrigerant and the oil content in the refrigerant are high due to the low intake temperature, it is necessary to install a large capacity accumulator capable of gas-liquid separation of a large amount of refrigerant.

However, when an accumulator according to the prior art is used for a horizontal compressor, there is a problem in reducing the size of a commercial refrigerator because the upper end of the accumulator protrudes above the upper end of the horizontal compressor.

To solve this problem, when the accumulator is installed horizontally, the effective volume of the accumulator is reduced compared to when the accumulator is installed vertically.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an accumulator for a compressor capable of increasing an effective volume compared to an accumulator according to the prior art while having a lower height than that of a horizontal compressor.

Additional aspects will be set forth in part in the description which follows and, in part, will be apparent from the description, or may be learned by practice of the presented embodiments.

In accordance with an aspect of the disclosure, an accumulator for a compressor is provided. The accumulator includes a body disposed on one side of a horizontal compressor perpendicular to a center line of the horizontal compressor, a stand pipe disposed to protrude from a lower surface of the body to an inside of the body, a suction opening provided on a side surface of the body, a baffle disposed above the stand pipe inside the body and including a plurality of baffle holes, and a screen disposed above the baffle.

A height from the lower surface of the body to an upper end of the stand pipe may be higher than a height from the lower surface of the body to a lower end of the suction opening.

A height from the lower surface of the body to an upper end of the stand pipe may be higher than a height from the lower surface of the body to an upper end of each of the plurality of baffle holes.

A height from the lower surface of the body to a lower end of the suction opening may be higher than the height from the lower surface of the body to the upper end of each of the plurality of baffle holes.

The baffle may be formed in a convex shape toward an upper surface of the body to surround an upper end portion of the stand pipe.

The screen may be formed in a convex shape corresponding to the baffle.

The baffle may be formed in a dome shape. The plurality of baffle holes may be formed on a side surface of the dome shape.

The baffle may include: a central portion facing the upper end of the stand pipe, a fixing portion fixed to the body, and an inclined portion connecting the central portion and the fixing portion. The plurality of baffle holes may be formed in the inclined portion.

The baffle may include: a central portion facing the upper end of the stand pipe, a fixing portion fixed to the body, a horizontal portion formed to extend inwardly from the fixing portion and parallel to the central portion, and an intermediate portion connecting the horizontal portion and the central portion. The plurality of baffle holes may be formed in the horizontal portion.

The stand pipe may include two stand pipes.

The suction opening may be formed as one end of a suction tube disposed on the side surface of the body perpendicularly to a center line of the stand pipe.

An upper end of the suction tube may be in contact with or adjacent to an upper surface of the body.

The stand pipe may include an oil hole formed in the stand pipe adjacent to the lower surface of the body.

An upper end of the screen may be in contact with an upper surface of the body.

An edge of the central portion of the baffle may be disposed to be in internal contact with the screen.

An upper end of the body may be positioned below an upper end of the horizontal compressor.

When an accumulator according to the prior art and an accumulator according to an embodiment of the disclosure have the same inner diameter of a body and the same outer diameter of a stand pipe, the accumulator according to an embodiment of the disclosure having the above structure may increase the effective volume compared to the accumulator according to the prior art.

In addition, in the accumulator for a compressor according to an embodiment of the disclosure, because a suction tube is disposed on a side surface of the body, the height of the accumulator may be lowered than that of the accumulator according to the prior art in which a suction pipe is disposed on the upper surface of the body. Therefore, an installation space of the compressor with the accumulator according to an embodiment of the disclosure may be reduced compared to a compressor with the accumulator according to the prior art.

Therefore, the accumulator for a compressor according to an embodiment of the disclosure having the above structure may increase the effective volume of the accumulator while having a lower height than that of a horizontal compressor.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a perspective view illustrating a horizontal compressor in which an accumulator for a compressor is disposed according to an embodiment of the disclosure;

FIG. 2 is a side view illustrating a horizontal compressor in which an accumulator for a compressor is disposed according to an embodiment of the disclosure;

FIG. 3 is a front view illustrating a horizontal compressor in which an accumulator for a compressor is disposed according to an embodiment of the disclosure;

FIG. 4 is a perspective view illustrating an accumulator for a compressor according to an embodiment of the disclosure;

FIG. 5 is a longitudinal sectional view of the accumulator for the compressor of FIG. 4 according to an embodiment of the disclosure;

FIG. 6 is a perspective view illustrating a baffle of an accumulator for a compressor according to an embodiment of the disclosure;

FIG. 7 is a perspective view illustrating a screen of an accumulator for a compressor according to an embodiment of the disclosure;

FIG. 8 is a longitudinal sectional view illustrating an accumulator for a compressor according to the prior art;

FIG. 9 is a perspective view illustrating an accumulator for a compressor according to an embodiment of the disclosure;

FIG. 10 is a longitudinal sectional view of the accumulator for the compressor of FIG. 9 according to an embodiment of the disclosure;

FIG. 11 is a perspective view illustrating a baffle of an accumulator for a compressor according to an embodiment of the disclosure;

FIG. 12 is a perspective view illustrating a screen of an accumulator for a compressor according to an embodiment of the disclosure;

FIG. 13 is a longitudinal sectional view illustrating an accumulator for a compressor according to an embodiment of the disclosure; and

FIG. 14 is a perspective view illustrating a baffle used in the accumulator for the compressor of FIG. 13 according to an embodiment of the disclosure.

Throughout the drawings, like reference numerals will be understood to refer to like parts, components, and structures

### DETAILED DESCRIPTION

The following description with reference to the accompanying drawings is provided to assist in a comprehensive understanding of various embodiments of the disclosure, as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The terms ‘first’, ‘second’, etc. may be used to describe diverse components, but the components are not limited by the terms. The terms may only be used to distinguish one component from the others. For example, without departing from the scope of the disclosure, a first component may be referred to as a second component, and similarly, a second component may also be referred to as a first component.

The terms used in embodiments of the disclosure may be construed as commonly known to those skilled in the art unless otherwise defined.

Further, the terms ‘leading end’, ‘rear end’, ‘upper side’, ‘lower side’, ‘top end’, ‘bottom end’, etc. used in the disclosure are defined with reference to the drawings. However, the shape and position of each component are not limited by the terms.

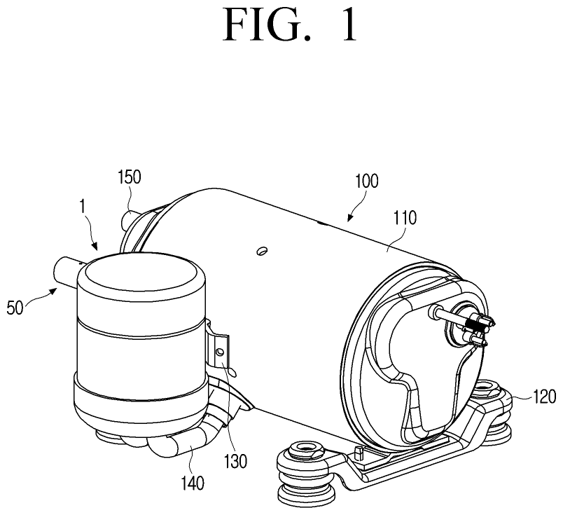

FIG. 1 is a perspective view illustrating a horizontal compressor in which an accumulator for a compressor is disposed according to an embodiment of the disclosure.

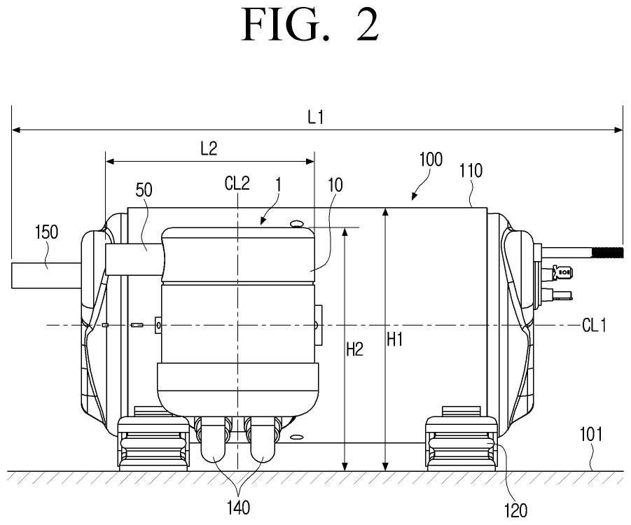

FIG. 2 is a side view illustrating a horizontal compressor in which an accumulator for a compressor is disposed according to an embodiment of the disclosure.

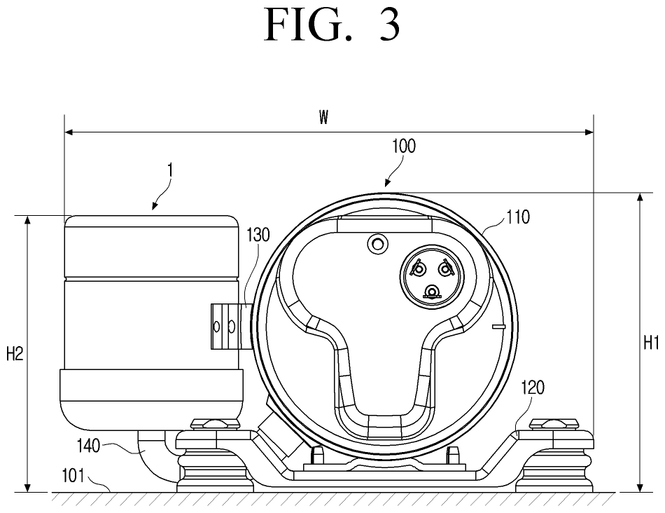

FIG. 3 is a front view illustrating a horizontal compressor in which an accumulator for a compressor is disposed according to an embodiment of the disclosure.

Referring to FIGS. 1 to 3, an accumulator 1 for a compressor according to an embodiment of the disclosure is disposed on one side of a horizontal compressor 100.

The horizontal compressor 100 may include a cylindrical main body 110 and a support part 120 formed to support the main body 110.

Because the horizontal compressor 100 is disposed in a horizontal direction, the center line CL1 of the horizontal compressor 100, that is, the center line CL1 of the main body 110 may be disposed parallel to the installation surface 101. For example, when the horizontal compressor 100 is a horizontal rotary compressor, a rotation axis of the horizontal rotary compressor corresponding to the center line CL1 of the main body 110 may be disposed parallel to the installation surface 101.

The support part 120 is fixed to the installation surface 101 and may be formed to support the main body 110. Accordingly, the center line CL1 of the horizontal compressor 100 may be disposed parallel to the lower surface of the support part 120.

Accordingly, the horizontal compressor 100 has a larger size in the horizontal direction compared to the installed height, that is, the size in the vertical direction unlike vertical compressors.

The main body 110 of the horizontal compressor 100 may include an inlet pipe 140 through which refrigerant flows into and a discharge pipe 150 through which compressed refrigerant is discharged.

The accumulator 1 for a compressor according to an embodiment of the disclosure is connected to the inlet pipe 140. Therefore, the refrigerant discharged from the accumulator 1 for a compressor according to an embodiment of the disclosure may flow into the horizontal compressor 100 through the inlet pipe 140.

The accumulator 1 for a compressor according to an embodiment of the disclosure may be disposed on one side of the horizontal compressor 100. The accumulator 1 may be fixed to the outer circumferential surface of the main body 110 of the horizontal compressor 100 with a fixing bracket 130.

The lower end of the accumulator 1 may be connected to the inlet pipe 140 of the horizontal compressor 100.

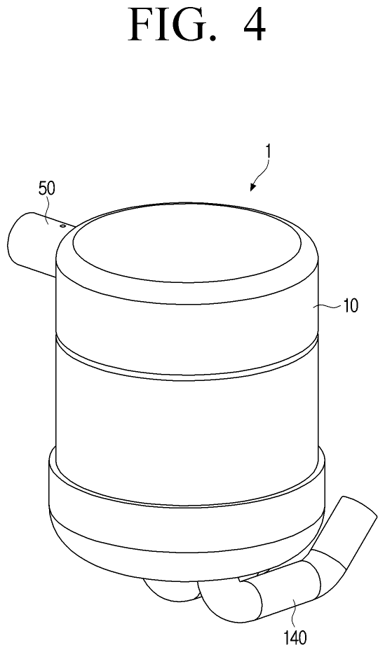

Hereinafter, the accumulator 1 for a compressor according to an embodiment of the disclosure will be described in detail with reference to FIGS. 4 to 7.

FIG. 4 is a perspective view illustrating an accumulator for a compressor according to an embodiment of the disclosure.

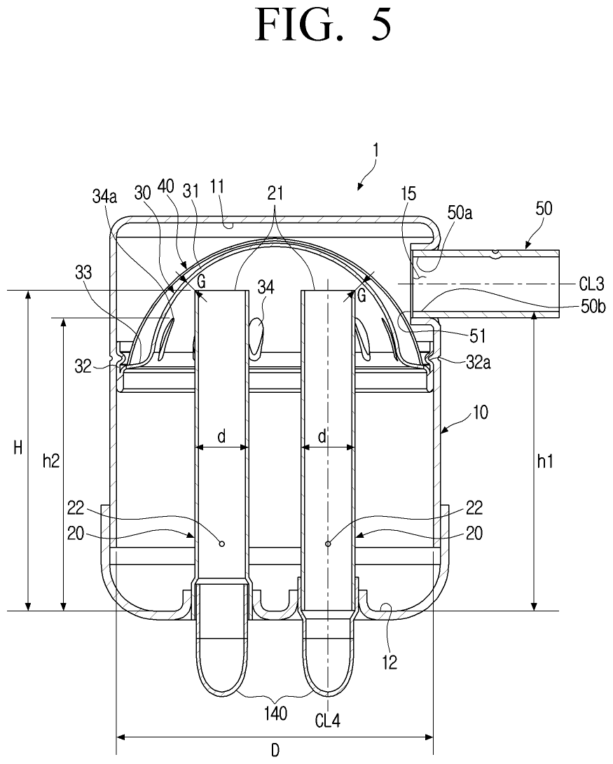

FIG. 5 is a longitudinal sectional view of the accumulator for the compressor of FIG. 4 according to an embodiment of the disclosure.

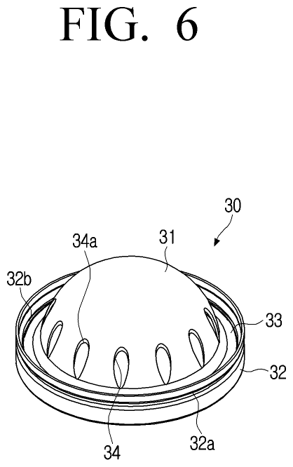

FIG. 6 is a perspective view illustrating a baffle of an accumulator for a compressor according to an embodiment of the disclosure.

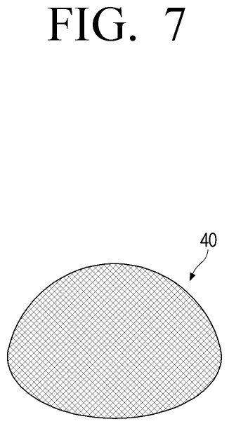

FIG. 7 is a perspective view illustrating a screen of an accumulator for a compressor according to an embodiment of the disclosure.

Referring to FIGS. 4 and 5, the accumulator 1 for a compressor according to an embodiment of the disclosure may include a body 10, a stand pipe 20, a baffle 30, and a screen 40.

The body 10 may be disposed on one side of the horizontal compressor 100. In other words, the body 10 may be disposed substantially perpendicular to the center line CL1 of the horizontal compressor 100. In detail, as illustrated in FIG. 2, the body 10 may be disposed on one side of the horizontal compressor 100 so that the center line CL2 of the body 10 is approximately perpendicular to the center line CL1 of the horizontal compressor 100. For example, the body 10 may be fixed to one side, that is, the outer circumferential surface of the horizontal compressor 100 by means of the fixing bracket 130.

The body 10 may be formed in a hollow cylindrical shape. An upper surface 11 of the body 10 is blocked, and a through hole 13 into which the stand pipe 20 is disposed may be provided in a lower surface 12 of the body 10.

Because the accumulator 1 according to this embodiment includes two stand pipes 20, two through holes 13 are provided in the lower surface 12 of the body 10.

Referring to FIGS. 4 and 5, the body 10 is formed in a cylindrical shape, but the shape of the body 10 of the accumulator 1 according to an embodiment of the disclosure is not limited thereto. As long as it can accommodate the refrigerant, the body 10 may be formed in various shapes. For example, the body 10 may be formed in the shape of an inverted truncated cone.

The stand pipe 20 may be disposed to protrude from the lower surface 12 of the body 10 into the inner space of the body 10. The stand pipe 20 is formed of a pipe having a circular cross-section, and the upper end 21 and the lower end thereof are open. The two stand pipes 20 may be formed in the same size.

The refrigerant inside the body 10 may be discharged to the horizontal compressor 100 through two stand pipes 20.

The stand pipe 20 may be disposed so that the upper end 21 of the stand pipe 20 is positioned as high as possible to increase the effective volume of the accumulator 1. The upper ends 21 of the two stand pipes 20 may be positioned at the same height H from the lower surface 12 of the body 10.

The stand pipe 20 may include at least one oil hole 22 formed adjacent to the lower surface 12 of the body 10. Oil accommodated in the body 10 may flow into the stand pipe 20 through the oil hole 22 and be supplied to the horizontal compressor 100.

A side surface of the body 10 may be provided with a suction opening 15 through which refrigerant flows into. The suction opening 15 may be disposed at a position as high as possible from the lower surface 12 of the body 10 to increase the effective volume of the accumulator 1.

A suction tube 50 may be disposed in the suction opening 15. For example, the suction opening 15 may be formed as one end 51 of the suction tube 50. In detail, a through hole may be formed in the side surface of the body 10, and one end 51 of the suction tube 50 may be fixed to the through hole. Then, one end 51 of the suction tube 50 forms the suction opening 15.

The suction tube 50 may be disposed substantially perpendicular to the stand pipe 20. In detail, the suction tube 50 may be disposed on the side surface of the body 10 such that the center line CL3 of the suction tube 50 is substantially perpendicular to the center line CL4 of the stand pipe 20.

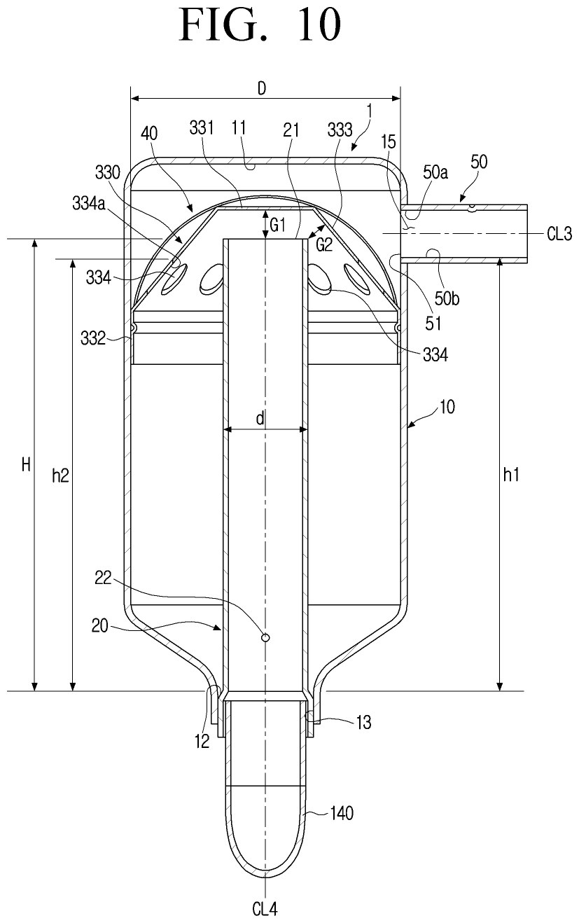

In the case of this embodiment illustrated in FIG. 5, one end 51 of the suction tube 50 is disposed to protrude into the body 10. However, when the one end 51 of the suction tube 50 protrudes, the effective volume of the accumulator 1 may be reduced. Therefore, the one end 51 of the suction tube 50 may be disposed so as not to protrude into the inside of the body 10 (see FIG. 10).

The suction tube 50 may be disposed so that the lower end 50b of the inner surface of the suction tube 50 is positioned lower than the upper end 21 of the stand pipe 20. In other words, the upper end 21 of the stand pipe 20 may be positioned above the lower end 50b of the inner surface of the suction tube 50.

In detail, the suction tube 50 may be disposed on the side surface of the body 10 so that the height h1 from the lower surface 12 of the body 10 to the lower end 50b of the inner surface of the suction tube 50 is equal to or less than the height H from the lower surface 12 of the body 10 to the upper end 21 of the stand pipe 20. That is, it may be H≥h1.

The upper end 50a of the inner surface of the suction tube 50 may be disposed to be positioned above the upper end 21 of the stand pipe 20. Therefore, the suction tube 50 may be disposed adjacent to the upper surface 11 of the body 10. Then, the upper end 51a of the inner surface of the suction tube 50 may be positioned above the upper end 21 of the stand pipe 20, and the lower end 50b of the inner surface of the suction tube 50 may be positioned below the upper end 21 of the stand pipe 20.

The baffle 30 may be disposed above the stand pipe 20 inside the body 10. The baffle 30 may be disposed above the stand pipe 20 and adjacent to the upper surface 11 of the body 10.

In detail, the baffle 30 may be disposed to surround the upper end portion of the stand pipe 20. For example, the baffle 30 may be formed in a convex shape toward the upper surface 11 of the body 10 to surround the upper end portion of the stand pipe 20. When the baffle 30 is formed in the convex shape toward the upper surface 11 of the body 10 in this way, the effective volume of the accumulator 1 may be increased.

In this embodiment, the baffle 30 is formed in a dome shape surrounding the upper end portions of the two stand pipes 20. In this case, the baffle 30 may be disposed at least 5 mm away from the upper end 21 of the stand pipe 20 so as not to disturb the flow of refrigerant flowing into the stand pipe 20. In other words, the baffle 30 may be disposed such that the minimum distance G between the upper end 21 of the stand pipe 20 and the baffle 30 is 5 mm or more.

The baffle 30 may be fixed to the inner circumferential surface of the body 10 and may include a plurality of baffle holes 34 through which the refrigerant passes.

Referring to FIG. 6, the baffle 30 may include a dome portion 31, a fixing portion 32, and a connection portion 33.

The dome portion 31 may cover the upper end portions of the two stand pipes 20 and may be formed in a dome shape.

The connection portion 33 may extend outward from the edge of the dome portion 31 and may be connected to the fixing portion 32. In other words, one end of the connection portion 33 may be connected to the edge of the dome portion 31 and the other end thereof may be connected to the fixing portion 32. The connection portion 33 may be formed in various shapes as long as it can connect the dome portion 31 and the fixing portion 32.

Accordingly, the dome portion 31 is formed in a shape protruding upward from the connection portion 33 and the fixing portion 32 toward the upper surface 11 of the body 10. The connection portion 33 and the fixing portion 32 may be positioned below the upper end 21 of the stand pipe 20.

The fixing portion 32 is formed to fixed to the body 10. The fixing portion 32 is formed in a ring shape. A groove 32a is formed at the center of the outer circumferential surface along the entire outer circumferential surface of the fixing portion 32. The groove 32a forms a protrusion 32b protruding toward the inside of the fixing portion 32. The baffle 30 may be fixed to the inner circumferential surface of the body 10 using the groove 32a of the fixing portion 32.

The dome portion 31, the connection portion 33, and the fixing portion 32 may be formed as one body. Alternatively, the dome portion 31 and the connection portion 33 may be formed separately from the fixing portion 32, and then coupled to the fixing portion 32. In this case, the dome portion 31 and the connection portion 33 may be formed as one body.

The plurality of baffle holes 34 may be formed in a side surface of the dome portion 31. At this time, the plurality of baffle holes 34 may be formed to be positioned below the upper end 21 of the stand pipe 20 to increase the effective volume of the accumulator 1.

In addition, the plurality of baffle holes 34 may be positioned below the lower end of the suction opening 15 so that the refrigerant flowing into the suction opening 15 may flow into the upper end 21 of the stand pipe 20 without being directly discharged through the baffle holes 34.

In detail, the plurality of baffle holes 34 may have the same size, and the upper ends 34a of the plurality of baffle holes 34 may be positioned at the same height from the lower surface 12 of the body 10. At this time, the upper end 34a of each of the plurality of baffle holes 34 may be formed to be positioned below the lower end of the suction opening 15.

For example, when the suction tube 50 is disposed in the suction opening 15, the baffle holes 34 may be formed so that the upper ends 34a of the baffle holes 34 are positioned lower than the lower end 50b of the inner surface of the suction tube 50. In other words, the plurality of baffle holes 34 may be formed such that the height h2 from the lower surface 12 of the body 10 to the upper end 34a of each of the plurality of baffle holes 34 is equal to or less than the height h1 from the lower surface 12 of the body 10 to the lower end 50b of the inner surface of the suction tube 50. That is, it may be h1≥h2.

Here, the upper end 34a of the baffle hole 34 refers to one end of the baffle hole 34 located at the highest place from the lower surface 12 of the body 10, that is, the farthest location from the lower surface 12 of the body 10. The lower end of the suction opening 15 refers to one end of the suction opening 15 located at the lowest place from the lower surface 12 of the body 10, that is, the closest location to the lower surface 12 of the body 10.

In addition, the upper end 21 of the stand pipe 20 may be positioned above the plurality of baffle holes 34. In detail, the upper end 34a of each of the plurality of baffle holes 34 may be positioned lower than the upper end 21 of the stand pipe 20. In other words, the plurality of baffle holes 34 may be formed such that the height h2 from the lower surface 12 of the body 10 to the upper end 34a of each of the plurality of baffle holes 34 is equal to or less than the height H from the lower surface 12 of the body 10 to the upper end 21 of the stand pipe 20. That is, it may be H≥h2.

The screen 40 may be disposed above the baffle 30. In other words, the screen 40 may be disposed between the baffle 30 and the upper surface 11 of the body 10. The screen 40 may be disposed in contact with or adjacent to the upper surface 11 of the body 10. Accordingly, the refrigerant flowing into the body 10 through the suction opening 15 may move to the baffle 30 after passing through the screen 40.

The screen 40 may be formed in a convex shape corresponding to the baffle 30. For example, the screen 40 may be formed in a dome shape corresponding to the dome shape baffle 30.

In this embodiment, the upper end of the screen 40 having the dome shape is spaced apart from the upper surface 11 of the body 10. However, in other embodiments, the screen 40 may be disposed so that the upper end of the screen 40 is in contact with the upper surface 11 of the body 10. When the upper end of the screen 40 is in contact with the upper surface 11 of the body 10, the effective volume of the accumulator 1 may be further increased.

In addition, in the case of this embodiment, the upper end of the baffle 30 is spaced apart from the screen 40. However, in other embodiments, the baffle 30 may be disposed so that the upper end of the baffle 30 is in contact with the lower surface of the upper end of the screen 40.

The screen 40 may be fixed to the fixing portion 32 of the baffle 30 on the upper side of the baffle 30. For example, the lower end of the screen 40 may be fixed to the fixing portion 32 of the baffle 30.

The screen 40 may be formed of a mesh. For example, the screen 40 may be formed of a 100×100 mesh, a wire of a diameter of 0.1 mm.

The refrigerant introduced into the body 10 through the suction opening 15 may be separated into gas refrigerant and liquid refrigerant by the screen 40 and the baffle 30. The liquid refrigerant may move to the lower portion of the body 10 through the plurality of baffle holes 34 provided in the baffle 30. The gas refrigerant may enter the upper end 21 of the stand pipe 20. The gas refrigerant introduced into the stand pipe 20 moves to the horizontal compressor 100 through the inlet pipe 140.

The gas refrigerant introduced into the horizontal compressor 100 is compressed and then discharged to the outside through the discharge pipe 150.

In this way, when the accumulator 1 for a compressor according to an embodiment of the disclosure is disposed on one side of the horizontal compressor 100, as illustrated in FIGS. 2 and 3, the upper end of the accumulator 1 does not protrude above the upper end of the horizontal compressor 100. In other words, in the horizontal compressor 100 in which the accumulator 1 according to an embodiment of the disclosure is disposed, the height H2 from the installation surface 101 to the upper end of the accumulator 1 is lower than the height H1 from the installation surface 101 to the upper end of the horizontal compressor 100 (H1>H2).

In addition, the length L2 of the accumulator 1 according to an embodiment of the disclosure is shorter than the length L1 of the horizontal compressor 100.

On the other hand, the width W of the horizontal compressor 100 in which the accumulator 1 according to an embodiment of the disclosure is disposed is a width obtained by adding the width of the accumulator 1 to the width of the horizontal compressor 100 alone, and is equal to the width of the horizontal compressor in which the accumulator according to the prior art is disposed.

Therefore, the horizontal compressor 100 having the accumulator 1 according to an embodiment of the disclosure may reduce the installation space of the horizontal compressor 100 compared to an accumulator of the prior art in which the height of the accumulator is higher than the height to the upper end of the horizontal compressor.

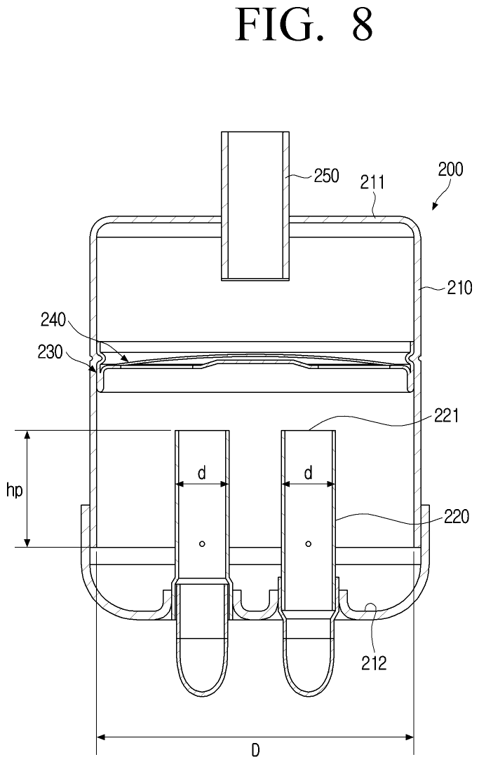

Hereinafter, an increase in the effective volume of the accumulator 1 according to an embodiment of the disclosure having the above structure will be described with reference to FIGS. 5 and 8.

FIG. 8 is a longitudinal sectional view illustrating an accumulator for a compressor according to the prior art.

Referring to FIG. 8, in the accumulator 200 according to the prior art, a suction pipe 250 through which refrigerant flows into is provided on the upper surface 211 of the body 210.

The two stand pipes 220 through which the refrigerant is discharged are vertically disposed on the lower surface 212 of the body 210.

In addition, the baffle 230 is disposed between the upper end 221 of the stand pipe 220 and the upper surface 211 of the body 210. The baffle 230 includes a plurality of baffle holes 234.

The screen 240 is disposed above the baffle 230. Therefore, the refrigerant introduced into the body 210 through the suction pipe 250 passes through the screen 240 and the baffle holes 234 of the baffle 230, and then is discharged to the outside of the accumulator 200 through the two stand pipes 220. The refrigerant discharged from the accumulator 200 moves to the horizontal compressor.

The effective volume of the accumulator 1 and 200 refers to the volume of the internal space of the body 10 and 210 in which the refrigerant does not flow into the stand pipe 20 and 220 and may be accommodated inside the body 10 and 210.

The effective volume of the accumulator 200 according to the prior art as illustrated in FIG. 8 is defined as the volume obtained by subtracting the volume of the two stand pipes 220 from the volume of the body 210 corresponding to the height Hp of the stand pipe 220. In other words, the effective volume Vp of the accumulator 200 according to the prior art may be calculated as follows.

Vp=Hp×π/4×D2−(2×π/4×d2×Hp)

Here, Hp represents the height from the lower surface 212 of the body 210 to the upper end 221 of the stand pipe 220, D represents the inner diameter of the body 210, and d represents the outer diameter of the stand pipe 220.

It may be considered that the effective volume of the accumulator 1 according to an embodiment of the disclosure as illustrated in FIG. 5 is defined as the volume obtained by subtracting the volume of the two stand pipes 20 from the volume of the body 10 having a height approximately corresponding to the height of the stand pipe 20, similar to the accumulator 200 according to the prior art. However, in the case of the embodiment of the disclosure, because the upper end 21 of the stand pipe 20 is positioned above the lower end 50b of the suction tube 50, the effective volume may be calculated using the height h1 from the lower surface 12 of the body 10 to the lower end 50b of the suction tube 50.

In detail, the effective volume V of the accumulator 1 according to an embodiment of the disclosure may be expressed as follows.

V=h1×π/4×D²−(2×π/4×d²×h1)−Vb—Vs

Here, h1 represents the height from the lower surface 12 of the body 10 to the lower end 50b of the suction tube 50, D represents the inner diameter of the body 10, d represents the outer diameter of the stand pipe 20, Vb represents the volume of a portion of the baffle 30 located below the lower end 50b of the suction tube 50, and Vs represents the volume of a portion of the screen 40 located below the lower end 50b of the suction tube 50.

In the case of the accumulator 1 according to an embodiment of the disclosure, the height H to the upper end 21 of the stand pipe 20 is higher than the height Hp to the upper end 221 of the stand pipe 220 according to the prior art (H>Hp). The height h1 to the lower end 50b of the suction tube 50 located below the upper end 21 of the stand pipe 20 is higher than the height Hp to the upper end 221 of the stand pipe 220 according to the prior art (h1>Hp).

Therefore, in the case in that the accumulator 200 according to the prior art and the accumulator 1 according to an embodiment of the disclosure have the same inner diameter D of the body 10 and 210 and the same outer diameter d of the stand pipe 20 and 220, when the effective volume Vp of the accumulator 200 according to the prior art and the effective volume V of the accumulator 1 according to an embodiment of the disclosure are compared with each other, the effective volume V of the accumulator 1 according to an embodiment of the disclosure may be increased by about 15% compared to the effective volume Vp of the accumulator 200 according to the prior art.

In addition, in the accumulator 1 for a compressor according to an embodiment of the disclosure, because the suction tube 50 is disposed on the side surface of the body 10, the height of the accumulator 1 may be lowered than the accumulator 200 according to the prior art in which the suction pipe 250 is disposed on the upper surface 211 of the body 210. Therefore, because the accumulator 1 according to an embodiment of the disclosure may be disposed so as not to protrude beyond the upper end of the compressor 100, the installation space of the compressor 100 having the accumulator 1 may be reduced compared to a compressor having the accumulator according to the prior art.

According to the accumulator 1 for a compressor according to an embodiment of the disclosure having such a structure, the effective volume of the accumulator 1 may be increased and the height of the accumulator 1 may be lower than that of the horizontal compressor 100.

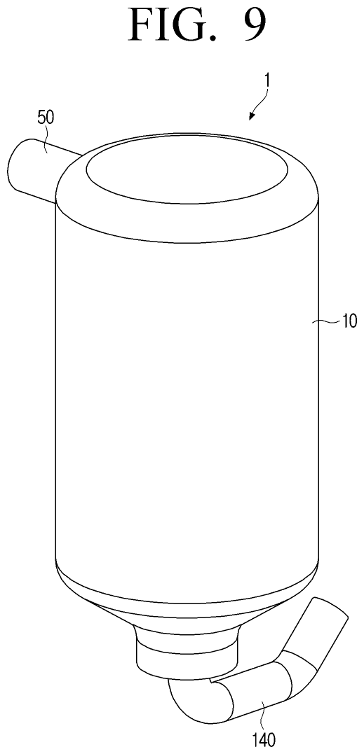

Hereinafter, an accumulator 1 for a compressor according to another embodiment of the disclosure will be described in detail with reference to FIGS. 9 to 12.

FIG. 9 is a perspective view illustrating an accumulator for a compressor according to an embodiment of the disclosure.

FIG. 10 is a longitudinal sectional view of the accumulator for the compressor of FIG. 9 according to an embodiment of the disclosure.

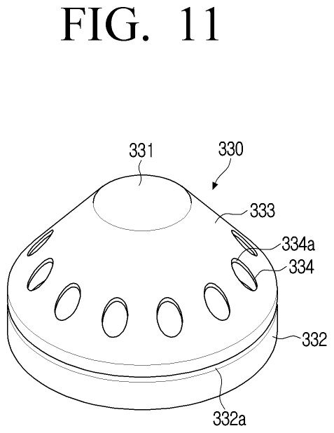

FIG. 11 is a perspective view illustrating a baffle of an accumulator for a compressor according to an embodiment of the disclosure.

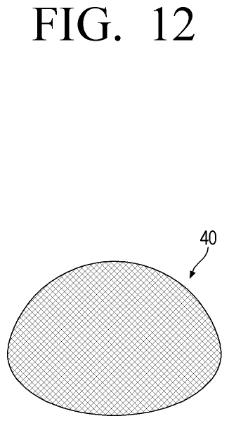

FIG. 12 is a perspective view illustrating a screen of an accumulator for a compressor according to an embodiment of the disclosure.

Referring to FIGS. 9 and 10, the accumulator 1 for a compressor according to an embodiment of the disclosure may include a body 10, a stand pipe 20, a baffle 330, and a screen 40.

The body 10 may be disposed on one side of the horizontal compressor 100 (see FIGS. 1 to 3). In other words, the body 10 may be disposed so that the center line of the body 10 is substantially perpendicular to the center line of the horizontal compressor 100. For example, the body 10 may be fixed to one side, that is, the outer circumferential surface of the horizontal compressor 100 by means of a fixing bracket.

The body 10 may be formed in a hollow cylindrical shape. An upper surface 11 of the body 10 is blocked, and a through hole 13 into which the stand pipe 20 is disposed may be provided in a lower surface 12 of the body 10.

The lower surface 12 of the body 10 may be formed in a tapered shape that becomes narrower as it goes downward.

In the case of the embodiment shown in FIGS. 9 and 10, the body 10 is formed in a cylindrical shape, but the shape of the body 10 of the accumulator 1 according to an embodiment of the disclosure is not limited thereto. As long as it can accommodate the refrigerant, the body 10 may be formed in various shapes. For example, the body 10 may be formed in the shape of an inverted truncated cone.

The stand pipe 20 may be disposed to protrude from the lower surface 12 of the body 10 into the inner space of the body 10. The stand pipe 20 is formed of a pipe having a circular cross-section, and the upper end 21 and the lower end thereof are open.

The stand pipe 20 may be disposed so that the upper end 21 of the stand pipe 20 is positioned as high as possible. As the upper end 21 of the stand pipe 20 is positioned higher, the effective volume of the accumulator 1 may be increase.

A side surface of the body 10 may be provided with a suction opening 15 through which refrigerant flows into. The suction opening 15 may be disposed at a position as high as possible to increase the effective volume of the accumulator 1.

A suction tube 50 may be disposed in the suction opening 15. For example, the suction opening 15 may be formed as one end 51 of the suction tube 50. In other words, a through hole may be formed in the side surface of the body 10, and one end 51 of the suction tube 50 may be fixed to the through hole.

The suction tube 50 may be disposed substantially perpendicular to the stand pipe 20. In detail, the suction tube 50 may be disposed on the side surface of the body 10 such that the center line CL3 of the suction tube 50 is substantially perpendicular to the center line CL4 of the stand pipe 20.

One end 51 of the suction tube 50 may protrude into the body 10, but when the suction tube 50 protrudes, the effective volume of the accumulator 1 may be reduced. Therefore, the suction tube 50 may be disposed so that the one end 51 of the suction tube 50 does not protrude from the inner surface of the body 10.

The suction tube 50 may be disposed so that the lower end of the suction opening 15, that is, the lower end 50b of the inner surface of the suction tube 50 is positioned lower than the upper end 21 of the stand pipe 20. In other words, the height h1 from the lower surface 12 of the body 10 to the lower end 50b of the inner surface of the suction tube 50 may be formed to be equal to or less than the height H from the lower surface 12 of the body 10 to the upper end 21 of the stand pipe 20 (H≥h1).

The upper end 50a of the inner surface of the suction tube 50 may be disposed to be positioned above the upper end 21 of the stand pipe 20. Therefore, the suction tube 50 may be disposed adjacent to the upper surface 11 of the body 10. Then, the upper end 50a of the inner surface of the suction tube 50 may be positioned above the upper end 21 of the stand pipe 20, and the lower end 50b of the inner surface of the suction tube 50 may be positioned below the upper end 21 of the stand pipe 20.

The baffle 330 may be disposed above the stand pipe 20 inside the body 10. The baffle 330 may be disposed at an upper portion of the body 10. That is, the baffle 330 may be disposed adjacent to the upper surface 11 of the body 10.

The baffle 330 may be fixed to the inner circumferential surface of the body 10 and may include a plurality of baffle holes 334 through which the refrigerant passes.

The baffle 330 may be formed in a convex shape toward the upper surface 11 of the body 10 to surround the upper end portion of the stand pipe 20. When the baffle 330 is formed in the convex shape toward the upper surface 11 of the body 10 as described above, the effective volume of the accumulator 1 may be increased.

In this case, the baffle 330 may be disposed at least 5 mm away from the upper end 21 of the stand pipe 20 so as not to disturb the flow of refrigerant flowing into the stand pipe 20. In other words, the baffle 330 may be disposed such that the minimum distance between the upper end 21 of the stand pipe 20 and the baffle 330 is 5 mm or more.

Referring to FIGS. 9 and 10, the baffle 330 may include a central portion 331, a fixing portion 332, and an inclined portion 333.

The central portion 331 may face the upper end 21 of the stand pipe 20 and may be formed in a disk shape. The baffle 330 may be formed so that the distance G1 between the upper end 21 of the stand pipe 20 and the central portion 331 is at least 5 mm or more.

The inclined portion 333 may obliquely extend downward from the edge of the central portion 331, and may be connected to an upper end of the fixing portion 332. In other words, the inclined portion 333 and the central portion 331 are formed in a protruding shape from the fixing portion 332. The inclined portion 333 and the central portion 331 may be formed in a truncated cone shape.

The fixing portion 332 is formed to fixed to the body 10. The fixing portion 332 is formed in a ring shape. A groove 332a is formed at the center of the outer circumferential surface along the entire outer circumferential surface of the fixing portion 332. The groove 332a forms a protrusion protruding toward the inside of the fixing portion 332. The baffle 330 may be fixed to the inner circumferential surface of the body 10 using the groove 332a of the fixing portion 332.

The inclined portion 333 may be formed to connect the central portion 331 and the fixing portion 332. In detail, one end of the inclined portion 333 is connected to the outer circumferential surface of the central portion 331 and the other end of the inclined portion 333 is connected to the upper end of the fixing portion 332. In this case, the inclined portion 333 may be formed such that the distance G2 between the inclined portion 333 and the upper end 21 of the stand pipe 20 is at least 5 mm or more.

The central portion 331, the inclined portion 333, and the fixing portion 332 may be formed as one body. Alternatively, the inclined portion 333 may be formed separately from the fixing portion 332, and then coupled to the fixing portion 332. In this case, the inclined portion 333 and the central portion 331 may be formed as one body.

The plurality of baffle holes 334 may be formed in the inclined portion 333. At this time, the plurality of baffle holes 334 may be formed to be positioned below the upper end 21 of the stand pipe 20 to increase the effective volume of the accumulator 1.

In addition, the plurality of baffle holes 334 may be positioned below the lower end 50b of the inner surface of the suction tube 50 so that the refrigerant discharged from the suction tube 50 flows into the upper end 21 of the stand pipe 20 without being directly discharged through the baffle holes 334.

In detail, the plurality of baffle holes 334 may have the same size, and the upper ends 334a of the plurality of baffle holes 334 may be formed to be positioned at the same height h2 from the lower surface 12 of the body 10.

At this time, the upper end 334a of each of the plurality of baffle holes 334 may be formed to be positioned below the lower end of the suction opening 15, that is, the lower end 50b of the inner surface of the suction tube 50. In detail, the height h2 from the lower surface 12 of the body 10 to the upper end 334a of each of the plurality of baffle holes 334 may be formed to be equal to or less than the height h1 from the lower surface 12 of the body 10 to the lower end 50b of the inner surface of the suction tube 50 (h1≥h2).

Here, the upper end 334a of the baffle hole 334 refers to one end of the baffle hole 334 located at the highest place from the lower surface 12 of the body 10, that is, the farthest location from the lower surface 12 of the body 10. The lower end 50b of the inner surface of the suction tube 50 refers to the portion of the inner circumferential surface of the suction tube 50 that is the lowest from the lower surface 12 of the body 10, that is, one end of the inner surface of the suction tube 50 located closest to the lower surface 12 of the body 10.

In addition, the upper end 334a of each of the plurality of baffle holes 334 may be formed to be positioned lower than the upper end 21 of the stand pipe 20. In other words, the plurality of baffle holes 334 may be formed such that the height h2 from the lower surface 12 of the body 10 to the upper end 334a of each of the plurality of baffle holes 334 is equal to or less than the height H from the lower surface 12 of the body 10 to the upper end 21 of the stand pipe 20 (H≥h2).

The screen 40 may be disposed above the baffle 330. In other words, the screen 40 may be disposed between the baffle 330 and the upper surface 11 of the body 10. The screen 40 may be disposed in contact with or adjacent to the upper surface 11 of the body 10.

The screen 40 may be formed in a convex shape corresponding to the baffle 330. For example, the screen 40 may be formed in a dome shape. In this embodiment, the upper end of the screen 40 having the dome shape is spaced apart from the upper surface 11 of the body 10. However, in other embodiments, the screen 40 may be disposed so that the upper end of the screen 40 is in contact with the upper surface 11 of the body 10. When the upper end of the screen 40 is in contact with the upper surface 11 of the body 10, the effective volume of the accumulator 1 may be further increased.

In addition, the outer circumferential surface of the central portion 331 of the baffle 330 may be disposed to be in contact with the inner surface of the screen 40 to increase the effective volume of the accumulator 1.

The screen 40 may be fixed to the fixing portion 332 of the baffle 330 on the upper side of the baffle 330. For example, the lower end of the screen 40 may be fixed to the fixing portion 332 of the baffle 330.

The screen 40 may be formed of a mesh. For example, the screen 40 may be formed of a 100×100 mesh, a wire of a diameter of 0.1 mm.

The refrigerant introduced through the suction tube 50 may be separated into gas refrigerant and liquid refrigerant by the screen 40 and the baffle 330. The liquid refrigerant may move to the lower portion of the body 10 through the plurality of baffle holes 334 provided in the baffle 330. The gas refrigerant may enter the upper end 21 of the stand pipe 20. The gas refrigerant introduced into the stand pipe 20 moves to the horizontal compressor 100 through the inlet pipe 140.

In the case of the accumulator 1 according to an embodiment of the disclosure, the height H from the lower surface 12 of the body 10 to the upper end 21 of the stand pipe 20 is higher than the height to the upper end of the stand pipe according to the prior art. The height h1 to the lower end 50b of the inner surface of the suction tube 50 located below the upper end 21 of the stand pipe 20 is higher than the height to the upper end of the stand pipe according to the prior art.

Therefore, in the case in that the accumulator according to the prior art and the accumulator according to an embodiment of the disclosure have the same inner diameter of the body and the same outer diameter of the stand pipe, when the effective volume of the accumulator according to the prior art and the effective volume of the accumulator according to an embodiment of the disclosure are compared with each other, the effective volume of the accumulator according to an embodiment of the disclosure may be larger than the effective volume of the accumulator according to the prior art.

In addition, in the accumulator for a compressor according to an embodiment of the disclosure, because the suction tube is disposed on the side surface of the body, the height of the accumulator may be lowered than that of the accumulator according to the prior art in which the suction pipe is disposed on the upper surface of the body. Therefore, because the accumulator according to an embodiment of the disclosure may be disposed so that the upper end thereof does not protrude beyond the upper end of the compressor, the installation space of the compressor with the accumulator may be reduced compared to a compressor with the accumulator according to the prior art.

According to the accumulator for a compressor according to an embodiment of the disclosure having such a structure, the effective volume of the accumulator may be increased while having a lower height than the horizontal compressor.

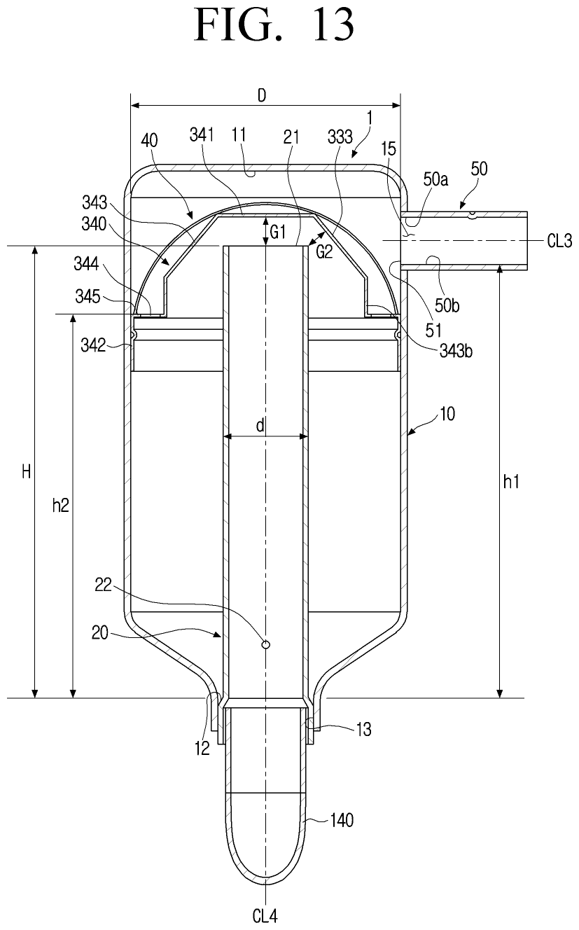

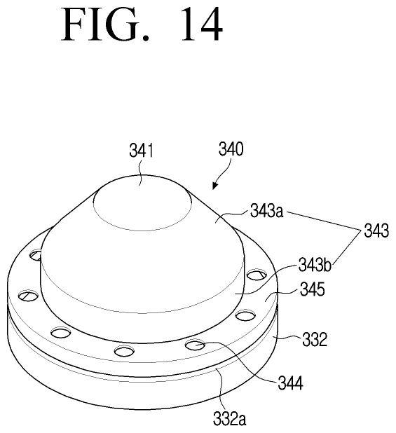

Hereinafter, an accumulator for a compressor according to an embodiment of the disclosure having a baffle of a different structure will be described in detail with reference to FIGS. 13 and 14.

FIG. 13 is a longitudinal sectional view illustrating an accumulator for a compressor according to an embodiment of the disclosure.

FIG. 14 is a perspective view illustrating a baffle used in the accumulator for the compressor of FIG. 13 according to an embodiment of the disclosure.

Referring to FIG. 13, an accumulator 1 for a compressor according to an embodiment of the disclosure may include a body 10, a stand pipe 20, a baffle 340, and a screen 40.

The body 10, the stand pipe 20, and the screen 40 are the same as those of the accumulator 1 for a compressor illustrated in FIG. 10. Therefore, detailed descriptions thereof are omitted.

The baffle 340 may be disposed above the stand pipe 20 inside the body 10. The baffle 340 may be disposed at the upper portion of the body 10. That is, the baffle 340 may be disposed adjacent to the upper surface 11 of the body 10.

The baffle 340 may be fixed to the inner circumferential surface of the body 10 and may include a plurality of baffle holes 344 through which the refrigerant passes.

The baffle 340 may be formed in a convex shape toward the upper surface 11 of the body 10 to surround the upper end portion of the stand pipe 20. When the baffle 340 is formed in the convex shape toward the upper surface 11 of the body 10 in this way, the effective volume of the accumulator 1 may be increased.

In this case, the baffle 340 may be disposed at least 5 mm away from the upper end 21 of the stand pipe 20 so as not to disturb the flow of refrigerant flowing into the stand pipe 20. In other words, the baffle 340 may be disposed such that the minimum distance between the upper end 21 of the stand pipe 20 and the baffle 340 is 5 mm or more.

Referring to FIGS. 13 and 14, the baffle 340 may include a central portion 341, a fixing portion 342, a horizontal portion 345, and an intermediate portion 343.

The central portion 341 may face the upper end 21 of the stand pipe 20 and may be formed in a disk shape. The central portion 341 may be formed to be spaced apart from the upper end 21 of the stand pipe 20 by a predetermined distance G1. For example, the central portion 341 may be spaced apart from the upper end 21 of the stand pipe 20 by at least 5 mm or more.

The fixing portion 342 is formed to fixed to the body 10. The fixing portion 342 is formed in a ring shape. A groove 342a may be formed at the center of the outer circumferential surface along the entire outer circumferential surface of the fixing portion 342. The groove 342a forms a protrusion protruding toward the inside of the fixing portion 342. The baffle 340 may be fixed to the inner circumferential surface of the body 10 using the groove 342a of the fixing portion 342.

The horizontal portion 345 may extend a predetermined length inward from the upper end of the fixing portion 342 and may be formed parallel to the central portion 341. A plurality of baffle holes 344 may be formed at regular intervals in the horizontal portion 345.

The intermediate portion 343 may be formed to connect the central portion 341 and the horizontal portion 345. In detail, one end of the intermediate portion 343 is connected to the outer circumferential surface of the central portion 341, and the other end of the intermediate portion 343 is connected to the inner end of the horizontal portion 345.

The intermediate portion 343 may include an inclined portion 343a and a vertical portion 343b. The inclined portion 343a may be connected to the outer circumferential surface of the central portion 341, and the vertical portion 343b may extend vertically from the lower end of the inclined portion 343a and be connected to the inner end of the horizontal portion 345. In this case, the inclined portion 343a may be formed so that the distance G2 between the inclined portion 343a and the upper end 21 of the stand pipe 20 is at least 5 mm or more.

However, the above-described shape of the intermediate portion 343 is only an example, and the shape of the intermediate portion 343 is not limited thereto. As long as the intermediate portion 343 can connect the central portion 341 and the horizontal portion 345, the intermediate portion 343 may be formed in various shapes.

The central portion 341, the intermediate portion 343, the horizontal portion 345, and the fixing portion 342 may be formed as one body. Alternatively, the central portion 341, the intermediate portion 343, and the horizontal portion 345 may be formed separately from the fixing portion 342, and then coupled to the fixing portion 342. In this case, the central portion 341, the intermediate portion 343, and the horizontal portion 345 may be formed as one body.

At this time, the plurality of baffle holes 344 may be formed to be positioned below the upper end 21 of the stand pipe 20 to increase the effective volume of the accumulator 1. In other words, the baffle 340 may be formed such that the horizontal portion 345 provided with the plurality of baffle holes 344 is positioned below the upper end 21 of the stand pipe 20.

In detail, the baffle 340 may be provided such that the height h2 from the lower surface 12 of the body 10 to the horizontal portion 345 of the baffle 340 is lower than the height H from the lower surface 12 of the body 10 to the upper end 21 of the stand pipe 20.

In addition, the horizontal portion 345 with the plurality of baffle holes 344 may be positioned below the lower end 50b of the inner surface of the suction tube 50 so that the refrigerant discharged from the suction tube 50 flows into the upper end 21 of the stand pipe 20 without being directly discharged through the baffle holes 344.

In detail, the baffle 340 may be provided so that the height h2 from the lower surface 12 of the body 10 to the horizontal portion 345 of the baffle 340 is lower than the height h1 from the lower surface 12 of the body 10 to the lower end 50b of the inner surface of the suction tube 50.

The screen 40 may be disposed above the baffle 340. In other words, the screen 40 may be disposed between the baffle 340 and the upper surface 11 of the body 10. The screen 40 may be disposed in contact with or adjacent to the upper surface 11 of the body 10.

The screen 40 may be formed in a convex shape corresponding to the baffle 340. For example, the screen 40 may be formed in a dome shape. In this embodiment, the upper end of the screen 40 having the dome shape is spaced apart from the upper surface 11 of the body 10. However, in other embodiments, the screen 40 may be disposed so that the upper end of the screen 40 is in contact with the upper surface 11 of the body 10. When the upper end of the screen 40 is in contact with the upper surface 11 of the body 10, the effective volume of the accumulator 1 may be increased.

In addition, the outer circumferential surface of the central portion 341 of the baffle 340 may be disposed to be in contact with the inner surface of the screen 40 to increase the effective volume of the accumulator 1.

The screen 40 may be fixed to the fixing portion 342 of the baffle 340 on the upper side of the baffle 340. For example, the lower end of the screen 40 may be fixed to the fixing portion 342 of the baffle 340.

The refrigerant introduced through the suction tube 50 may be separated into gas refrigerant and liquid refrigerant by the screen 40 and the baffle 340. The liquid refrigerant may move to the lower portion of the body 10 through the plurality of baffle holes 344 provided in the baffle 340. The gas refrigerant may flow into the upper end 21 of the stand pipe 20. The gas refrigerant introduced into the stand pipe 20 moves to the horizontal compressor 100 through the inlet pipe 140.

In the case of the accumulator 1 according to an embodiment of the disclosure, the height to the upper end 21 of the stand pipe 20 is higher than the height to the upper end of the stand pipe according to the prior art. The height to the lower end 50b of the suction tube 50 located below the upper end 21 of the stand pipe 20 is higher than the height to the upper end of the stand pipe according to the prior art.

Therefore, in the case in that the accumulator according to the prior art and the accumulator according to an embodiment of the disclosure have the same inner diameter of the body and the same outer diameter of the stand pipe, the effective volume of the accumulator according to an embodiment of the disclosure may be larger than the effective volume of the accumulator according to the prior art.

In addition, in the accumulator for a compressor according to an embodiment of the disclosure, because the suction tube is disposed on the side surface of the body, the height of the accumulator may be lowered than that of the accumulator according to the prior art in which the suction pipe is disposed on the upper surface of the body. Therefore, because the accumulator according to an embodiment of the disclosure may be disposed so that the upper end thereof does not protrude beyond the upper end of the compressor, the installation space of the compressor with the accumulator may be reduced compared to a compressor with the accumulator according to the prior art.

According to the accumulator for a compressor according to an embodiment of the disclosure having such a structure, the effective volume of the accumulator may be increased while having a lower height than the horizontal compressor.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An accumulator for a compressor that is disposed on one side of a horizontal compressor, the accumulator comprising:
a body disposed on one side of the horizontal compressor perpendicular to a center line of the horizontal compressor;
a stand pipe disposed to protrude from a lower surface of the body to an inside of the body;
a suction opening provided on a side surface of the body;
a baffle disposed above the stand pipe inside the body and including a plurality of baffle holes; and
a screen disposed above the baffle.

2. The accumulator of claim 1, wherein a height from the lower surface of the body to an upper end of the stand pipe is higher than a height from the lower surface of the body to a lower end of the suction opening.

3. The accumulator of claim 1, wherein a height from the lower surface of the body to an upper end of the stand pipe is higher than a height from the lower surface of the body to an upper end of each of the plurality of baffle holes.

4. The accumulator of claim 3, wherein a height from the lower surface of the body to a lower end of the suction opening is higher than the height from the lower surface of the body to the upper end of each of the plurality of baffle holes.

5. The accumulator of claim 1, wherein the baffle is formed in a convex shape toward an upper surface of the body to surround an upper end portion of the stand pipe.

6. The accumulator of claim 5, wherein the screen is formed in a convex shape corresponding to the baffle.

7. The accumulator of claim 5,
wherein the baffle is formed in a dome shape, and
wherein the plurality of baffle holes are formed on a side surface of the dome shape.

8. The accumulator of claim 5,
wherein the baffle comprises:
a central portion facing the upper end portion of the stand pipe;
a fixing portion fixed to the body; and
an inclined portion connecting the central portion and the fixing portion, and
wherein the plurality of baffle holes are formed in the inclined portion.

9. The accumulator of claim 5,
wherein the baffle comprises:
a central portion facing the upper end portion of the stand pipe;
a fixing portion fixed to the body;
a horizontal portion formed to extend inwardly from the fixing portion and parallel to the central portion; and
an intermediate portion connecting the horizontal portion and the central portion, and
wherein the plurality of baffle holes are formed in the horizontal portion.

10. The accumulator of claim 1, wherein the stand pipe comprises two stand pipes.

11. The accumulator of claim 1, wherein the suction opening is formed as one end of a suction tube disposed on the side surface of the body perpendicularly to a center line of the stand pipe.

12. The accumulator of claim 11, wherein an upper end of the suction tube is in contact with or adjacent to an upper surface of the body.

13. The accumulator of claim 1, wherein the stand pipe comprises an oil hole formed in the stand pipe adjacent to the lower surface of the body.

14. The accumulator of claim 1, wherein an upper end of the screen is in contact with an upper surface of the body.

15. The accumulator of claim 1, wherein an upper end of the body is positioned below an upper end of the horizontal compressor.
